(19) United States
(12) Patent Application Publication
(10) Pub. No.: US 2024/0183468 A1
(43) Pub. Date: Jun. 6, 2024

(54) THERMOPLASTIC WELDED SEALING SYSTEM AND METHOD FOR THERMOSET COMPOSITE PIPE JOINTS

(71) Applicant: Saudi Arabian Oil Company, Dhahran (SA)

(72) Inventors: Chris Worrall, Cambridge (GB); Pedro De Sousa Santos, Ely (GB); Abderrazak Traidia, Lussan (FR); Thibault Villette, Belfort (FR); Anwar Parvez, Dhahran (SA); Abdulaziz Asiri, Dhahran (SA); Kees Rookus, Zwolle (NL); Philip Berry, Geddington (GB)

(73) Assignee: Saudi Arabian Oil Company, Dhahran (SA)

(21) Appl. No.: 18/525,599

(22) Filed: Nov. 30, 2023

Related U.S. Application Data
(60) Provisional application No. 63/385,758, filed on Dec. 1, 2022.

(51) Int. Cl. F16L 13/02; B29C 65/00; B29C 65/36

(52) U.S. Cl. CPC F16L 13/0209; B29C 65/366; B29C 66/5221

(57) ABSTRACT

A system for coupling reinforced thermosetting resin pipes includes a first pipe having a tapered, spigot end, wherein a portion of an external surface of the tapered, spigot end of the first pipe is bonded to a first thermoplastic material and a second pipe having a tapered, socket end adapted to internally receive the tapered, spigot end of the first pipe, wherein a portion of an internal surface of the tapered, socket end of the second pipe is bonded to a second thermoplastic material. A method of coupling the first pipe and the second pipe includes inserting the first pipe into the second pipe; coupling the first pipe to the second pipe via a mechanical joint; and employing a thermal joining process to bond the first thermoplastic material to the second thermoplastic material by heating the first and second thermoplastic materials to melt the first and second thermoplastic materials.

### BACKGROUND

RTR (Reinforced Thermosetting Resin) pipe is an acronym given to a broad family of fiber reinforced thermosetting pipes manufactured via a filament winding process. The reinforcement is generally glass fiber and the resin (matrix) is a thermoset polymer, traditionally polyester, vinyl-ester, or epoxy depending on the nature of the transported fluids in the pipe and the service temperature. This has led to the development of 3 main product lines for RTR pipes: GRP (Glass Reinforced Polyester), GRV (Glass Reinforced Vinylester) and GRE (Glass Reinforced Epoxy) pipes.

RTR pipes are generally produced in rigid segments of about 10-12 meters in length and transported onsite before being eventually assembled (jointed) to each other to the required length. The historical development of RTR began with the need to replace heavy concrete and steel pipes used in utilities and potable/sewage water systems. However, the use of RTR pipes in higher value applications such as oil and gas (O&G) service (particularly GRE), has gained a great deal of attention and acceptance. Currently, thousands of kilometers of RTR pipes are installed globally (particularly in the Middle East region) on a yearly basis to meet the need of critical applications such as high pressure water injection and sour crude oil flowlines. The experience of O&G operators over the last decades has shown that RTR is a mature technology and can be an economical alternative to traditional carbon steel pipes, particularly in view of the fact that RTR pipe is not subject to the same corrosion seen in carbon steel piping. Depending on the manufacturer's product portfolio, RTR line pipes are generally available in diameters ranging from 1½″ (inches) to 44″ and can be designed to handle pressures ranging from 150 psi to 4000 psi and temperatures up to 210° F.

Within the RTR pipe manufacturing industry it is well known that the joint/connection in an RTR pipeline system is often the limiting component towards a higher temperature and pressure operating envelope. The envelope is often defined in terms of the product pressure in view of the diameter (i.e., larger diameter RTR pipe generally cannot handle the same pressure as smaller diameter piping). Indeed, the experience of O&G operators has shown that most failures/leaks in RTR pipe systems are associated with joint failures. This could potentially reduce the confidence in the material and technology. Additionally, traditional jointing systems exhibit lower fracture toughness and have few applications in gaseous systems due to the foreseeable leak path that may be encountered during operation.

A number of proprietary joint designs have been developed over the years by the manufacturers, which can generally be grouped into two main types/categories; adhesive/bonded joints and interference joints. The former, adhesive/bonded joints, relies on an adhesive (or a laminate in case of wrapped/laminated joints) to transfer the load from one pipe to another and the performance/limitation of such joints is often associated with proper surface preparation, particularly in field conditions. The latter, interference joints, relies on a solid contact and direct load transfer between the two RTR pipes to be jointed, such as threaded and key-lock joints. A combination of both techniques (i.e, adhesive and interference) is also possible (e.g., the Injected Mechanical Joint—IMJ).

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for coupling pipes which includes a first pipe having a tapered, spigot end, where a portion of an external surface of the tapered, spigot end of the first pipe is bonded to a first thermoplastic material; and a second pipe having a tapered, socket end adapted to internally receive the tapered, spigot end of the first pipe, where a portion of an internal surface of the tapered, socket end of the second pipe is bonded to a second thermoplastic material; where the first pipe and the second pipe may be made from a reinforced thermosetting resin (RTR) material; where when the first pipe is internally received by the second pipe, the portion of the external surface of the tapered, spigot end of the first pipe can be positioned to align with the portion of the internal surface of the tapered, socket end of the second pipe, thereby forming a sealing area; where, upon application of a thermal joining process to the first thermoplastic material and the second thermoplastic material, an amount of heat of the thermal joining process is sufficient to melt the first thermoplastic material and the second thermoplastic material such that, when the heat is removed, a hardened thermoplastic material formed from the first and second thermoplastic materials melting together and subsequently hardening seals the first pipe to the second pipe. Hardening here generally refers to the process of a thermoplastic material cooling to below its glass transition temperature and becoming glassy with increased modulus. Hardening also may correspond to when properties of the solid thermoplastic material are regained.

In another aspect, embodiments disclosed herein relate to a method of coupling a first pipe having a tapered, spigot end and a second pipe having a tapered, socket end adapted to internally receive the tapered, spigot end of the first pipe, where the first pipe and the second pipe are made from a reinforced thermosetting resin (RTR) material and wherein a portion of an external surface of the tapered, spigot end of the first pipe is bonded to a first thermoplastic material and a portion of an internal surface of the tapered, socket end of the second pipe is bonded to a second thermoplastic material, wherein the method includes: inserting the first pipe into the second pipe; coupling the first pipe to the second pipe via a mechanical joint such that the portion of the external surface of the first pipe aligns with the portion of the internal surface of the second pipe to form a sealing area; and employing a thermal joining process to bond the first thermoplastic material to the second thermoplastic material by heating the first and second thermoplastic materials to melt the first and second thermoplastic materials such that, when the heat is removed, the hardened thermoplastic material seals the first pipe to the second pipe at the sealing area.

Other aspects and advantages of the claimed subject matter will be apparent from the following description and the appended claims.

### BRIEF DESCRIPTION OF DRAWINGS

FIGS. 1A and 1B show an integral and a coupled joint, respectively.

FIGS. 2A-2C show a key-lock joint, a threaded joint, and an injection mechanical joint, respectively.

FIGS. 3A-3C are schematic representations of overloading failure of a key-lock RTR joint, a threaded RTR joint, and an injection mechanical joint, respectively.

FIG. 4 is a schematic of a thermoplastic interlayer located internally to a threaded joint in accordance with one or more embodiments of the present disclosure.

FIG. 5A is a schematic of a threaded joint in accordance with one or more embodiments of the present disclosure.

FIG. 5B is a schematic of a thermoplastic welded seal of a threaded joint in accordance with one or more embodiments of the present disclosure.

FIG. 6 is a schematic of a thermoplastic welded seal of a key-lock joint in accordance with one or more embodiments of the present disclosure.

### DETAILED DESCRIPTION

Threaded joints are traditionally used for high pressure RTR pipes. These can be either “integral” (i.e., a connection that does not use a joining member/coupler to transfer the load from one pipe to the other) or using a “coupler.” Although threaded joints can achieve outstanding performance, in terms of pressure rating and sealing capacity, the experience of O&G operators has shown that failures can happen. The general opinion is that the failures are associated with improper installation by the jointers (pipe misalignment, over-torqueing, improper/insufficient taping of the thread compound—TEFLON® (registered trademark of the Chemours Company FC, LLC), etc.).

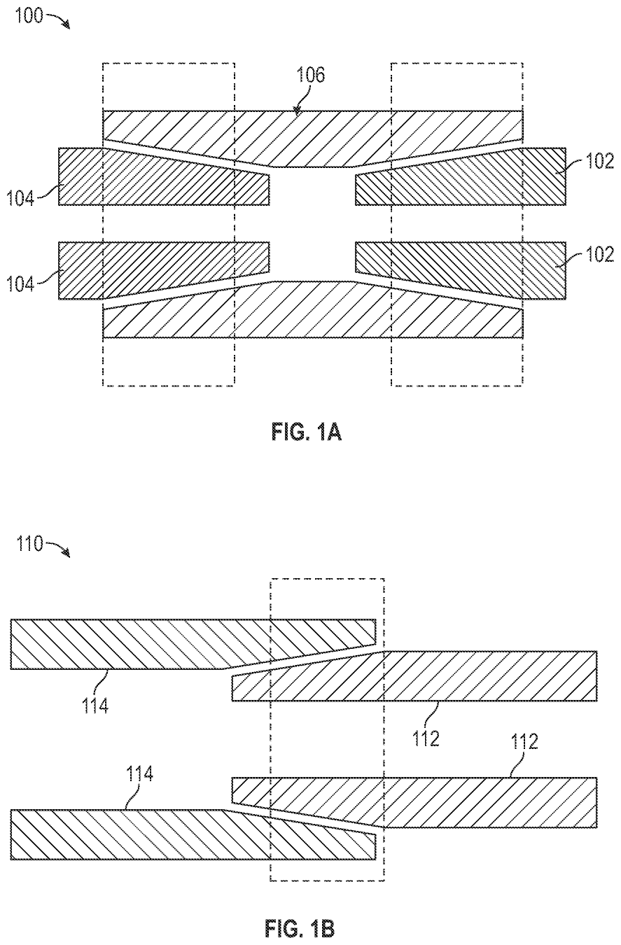

In general, high-pressure RTR pipes make use of interference or mechanical joints (threaded or key-lock joints), while lower pressure ratings can be achieved with adhesive and laminate joints. Interference joints can be coupled joints, shown in FIG. 1A, or integral joints, shown in FIG. 1B. In FIG. 1A, the joint 100 is formed between a first RTR pipe 102 having a spigot end and a second RTR pipe 104 also having a spigot end by employing a coupler pipe 106 having two socket ends. In FIG. 1B, joint 110 is formed between a first RTR pipe 112 having a spigot end and a second RTR pipe 114 having a socket end.

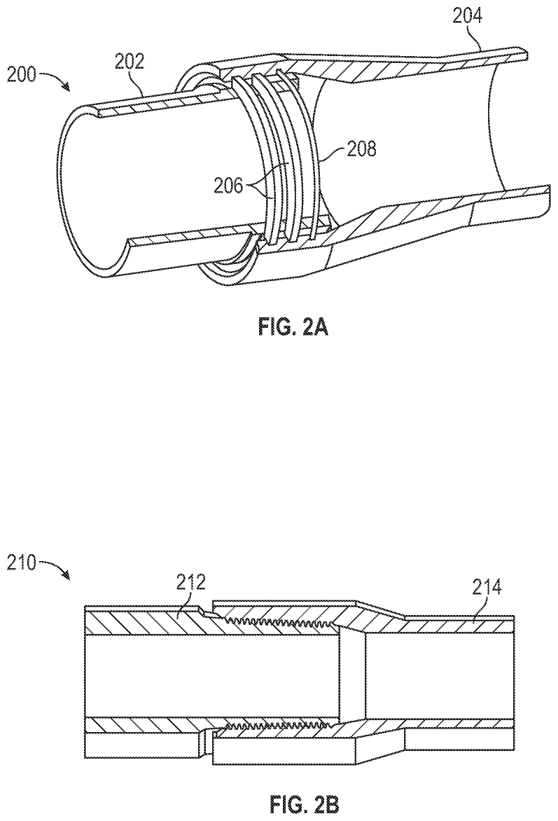

Three common types of integral and coupled joints include key-lock joints, threaded joints, and injected mechanical joint, shown in FIGS. 2A-2C, respectively. Referring to FIG. 2A, joint 200 is formed between an RTR pipe 202 having a spigot end and an RTR pipe 204 having a socket end using locking strips 206 and a rubber sealing (O-ring) 208. Referring to FIG. 2B, joint 210 is formed between a first RTR pipe 112 having a threaded spigot end and a second RTR pipe 114 having a threaded socket end. Finally, referring to FIG. 2C, joint 220 is formed between a first RTR pipe having a threaded spigot end 222 and a threaded socket end 224 using O-rings 226 and 228 and thermoset resin 230 injected through inlet 232.

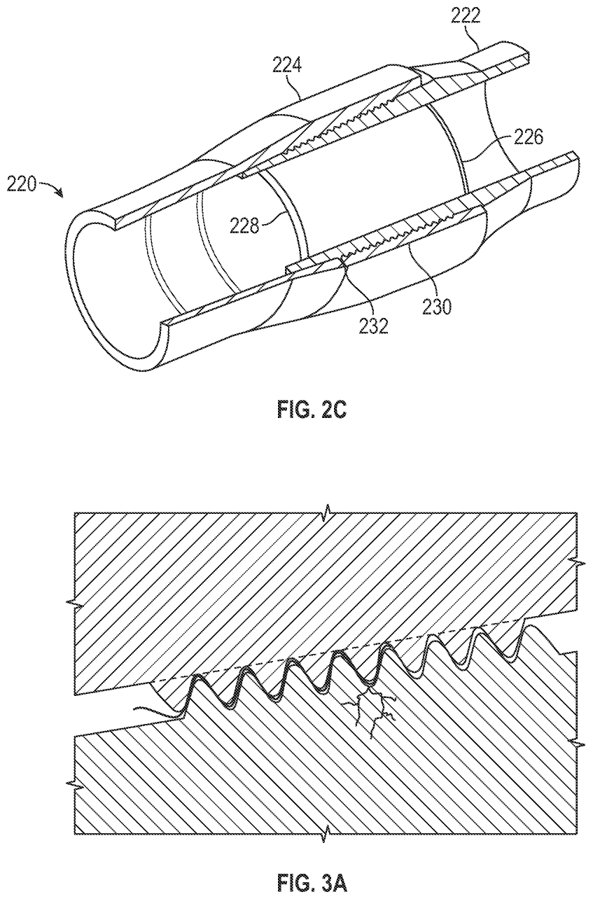

A typical failure mechanism of threaded joints is illustrated in FIG. 3A. A poor installation can result in imperfections/cavities along the contact surface between the spigot and the socket. In operation, fluid (e.g., water) at high pressure and high temperature could ingress into these cavities (step #1) and create a high pressure fluid film (step #2) which would slowly propagate along the spigot-socket interface. In some cases, the creep of the resin at the interface can aggravate the water propagation at the interface. As the ingress progresses, the contact pressure on the initial threads is eliminated and the excess load is transferred to the nearby threads, which eventually leads to overloading failure (step #3).

FIGS. 3B and 3C illustrate similar failure mechanisms in key-lock joints and injection mechanical joints, which are also sometimes employed in O&G applications. In a typical failure mechanism of a key-lock joint, fluid and/or gas may ingress across the elastomeric O-ring. Not only does this mechanism allow release of oil and/or gas, but it can also lead to quicker disintegration of the O-ring and more frequent replacement. In a typical failure mechanism of an injection mechanical joint, fluids and/or gas may ingress across the injected thermoset resin and leak through the injection inlet and towards the O-ring, resulting in a similar situation as described for key-lock joints.

One or more embodiments of the present disclosure introduce a jointing technique that provides a better seal for common mechanical joints in RTR pipe technology. A goal of such embodiments is to reinforce current jointing technologies for RTR pipes (low and high pressure) with a thermoplastic welded seal (TPWS), such that fluid and/or gas ingress and leakage through the mechanical joints is significantly reduced, if not eliminated.

Therefore, one or more embodiments of the present disclosure relate to a system and method for jointing of high pressure reinforced thermosetting resin (RTR) pipes. In particular, the system and method include using a combination of conventional mechanical jointing techniques with a thermoplastic welded seal to achieve an RTR joint having an enhanced seal. In one or more embodiments, the system and method may involve jointing (1) a “weldable” RTR pipe with a tapered spigot end bonded to a tie layer (interlayer) comprising at least a thermoplastic material and (2) a “weldable” RTR pipe with a tapered socket end bonded to a tie layer comprising at least a thermoplastic material, or alternatively a reinforced thermoplastic coupler comprising at least a thermoplastic material.

In accordance with one or more embodiments, a method of coupling two RTR pipes includes jointing the RTR pipes using a mechanical joint and then forming a thermoplastic welded seal. It should be noted that the thermoplastic welded seal described herein may be used in combination with any conventional mechanical joint such as, for example, a key-lock joint, a threaded joint, and an injection mechanical joint, among others. Accordingly, while certain mechanical jointing systems, such as a threaded joint, may be used to describe the inventive system including a thermoplastic welded seal, such embodiments are not meant to be limiting.

At the outset, each of an RTR pipe having a tapered-spigot end and an RTR pipe having a tapered, socket end is loaded with an interlayer. The interlayer includes at least a thermoplastic material. In some embodiments the interlayer of the RTR pipe having a tapered, spigot end is the same as the interlayer of the RTR pipe having a tapered, socket end. In other, embodiments, the interlayer of the RTR pipe having a tapered, spigot end is different from the interlayer of the RTR pipe having a tapered, socket end.

The interlayer includes at least a thermoplastic material. Suitable thermoplastic materials include any weldable thermoplastic material, such as a thermoplastic polymer, traditionally used in the O&G industry known by those skilled in the art. For example, the interlayer may at least include one or more of polyolefins such as high-density polyethylene (HDPE), polyethylene of raised temperature (PE-RT), polyvinylidene fluoride (PVDF), polyether ether ketone (PEEK), polyetherketoneketone (PEKK), polyphenylene sulfide (PPS), polyaryletherketone (PAEK), polyamide (PA), polytetrafluoroethylene (PTFE), polyketone (POK), and polyetherimide (PEI), among others.

In one or more embodiments, the interlayer includes a susceptor. Susceptors may be included in the thermoplastic interlayer to aid in the formation of the thermoplastic welded seal, such as by heating and melting the thermoplastic interlayer. Therefore, in one or more embodiments, the susceptor is a conducting electromagnetic susceptor, and is used in thermoplastic interlayers that are to be inductively welded. In some embodiments, the susceptor is layered onto the RTR pipe prior to deposition of the thermoplastic material on top of the susceptor layer. Such layering may be achieved by spraying the susceptor on the RTR pipe, by wrapping the RTR pipe with susceptor-containing mesh, among others. In other embodiments, the thermoplastic material is layered onto the RTR pipe and the susceptor is deposited on top of the thermoplastic material layer. External layering of the susceptor on the thermoplastic material may be carried out by spraying or wrapping, as above. In yet other embodiments, the susceptor is dispersed as particles within a thermoplastic matrix.

The tapered ends of the RTR pipes, on the respective surface to-be-joined, i.e., inner surface of the socket end and outer surface of the spigot end, may be prepared prior to loading with the interlayer. Such preparation of the surface aims to bring the surface the adequate rugosity to promote satisfactory adhesion between the RTR pipe and the thermoplastic material. The respective surfaces of the RTR pipes may be prepared by grit blasting, micro-machining, among others. By grit blasting the surface of an RTR pipe, the required microscopic rugosity to attain sufficient bond strength may be achieved, while protecting structural integrity of the pipe. Micro-machining, on the other hand, aims to create millimetric or sub-millimetric grooves on the tapered ends of the RTR pipes. The grooves may be machined circumferentially (normal to the pipe axis) to provide 1) a significantly larger contact and welding surface, 2) accrued resistance against shear loads exerted on the interface during pipe operation, and 3) increased free permeation path to fight the fluid and gas ingress through the sealing.

Once the respective surfaces of the RTR pipe having a tapered, spigot end and the RTR pipe having a tapered, socket end are prepared, the interlayer may be loaded on the RTR pipes and subsequently bonded to the RTR. Bonding of the interlayer and the RTR pipes is carried out according to methods and systems described in U.S. patent application Ser. No. 17/644,194, which is incorporated herein by reference. Briefly, the interlayer may be bonded to the RTR using a thermal joining process, such as friction welding, such that a sufficient bond strength between the thermoplastic material of the interlayer and the RTR of the RTR pipe is achieved.

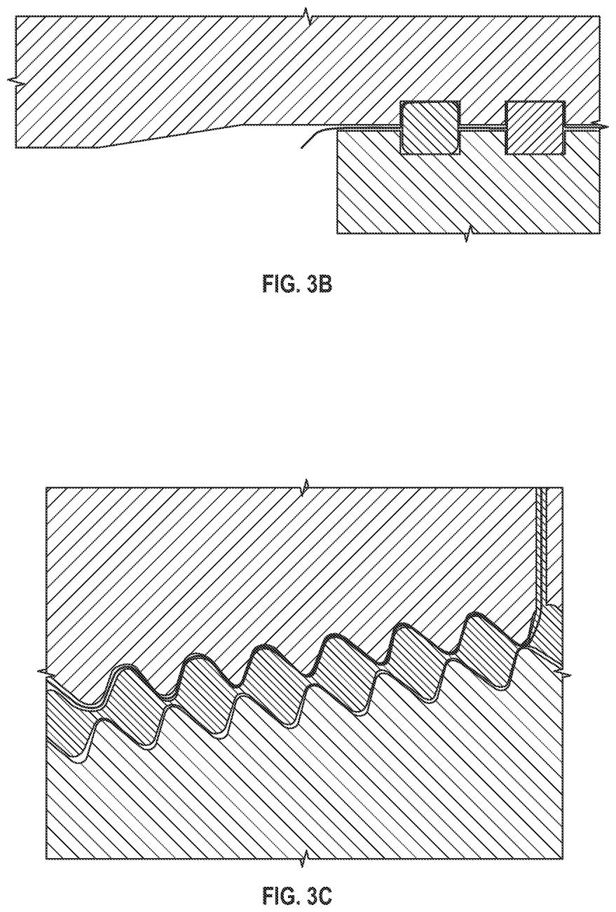

In one or more embodiments, the thermoplastic interlayer is located in an area of the RTR pipe that is adjacent to the area of the RTR pipe that may participate in the conventional mechanical joint of the RTR pipe. In particular, the thermoplastic interlayer may be located internally to the mechanical jointing area, as shown in FIG. 4. Herein, a location that is “internal” on an RTR pipe having a tapered spigot or socket end refers to a location that, once two pipes are mechanically coupled to each other, would be on the side of the pipe that is inside the mechanical joint. As shown in FIG. 4, an RTR pipe 400 having tapered spigot end 401 has a thermoplastic interlayer 402 located internal to a threaded coupling area 404. Such placement of the thermoplastic interlayer may be similar on an RTR pipe having a tapered, socket end, e.g., the thermoplastic interlayer may be placed internal to the threaded coupling area of the tapered, socket end.

An RTR pipe having a tapered, spigot end and a mechanical coupling area that is loaded with a thermoplastic interlayer may be inserted into an RTR pipe having a tapered, socket end and a mechanical coupling area that is loaded with a thermoplastic interlayer. In accordance with the present disclosure, formation of a thermoplastic welded seal between the two RTR pipes may occur directly after mechanical coupling of the pipes or concurrent to mechanical coupling of the pipes. Accordingly, although sequence of mechanical coupling followed by thermal coupling may be described herein, such sequence is not meant to be limiting.

Notably, the surfaces of the thermoplastic interlayers to be joined, such as by induction welding, may be relatively smooth to promote intimate contact and avoid the inclusion of voids. The surfaces to be joined may be prepared such that they are free of any chemical agents including oils used to facilitate extrusion or demolding. Thus, in one or more embodiments, prior to inserting the spigot end into the socket end, the thermoplastic interlayers may be cleaned with compressed air to remove dust, followed by solvent degreasing using Industrial Methylated Spirit (IMS) or Isopropyl alcohol (IPA) solvent to remove dust and all surface contaminants.

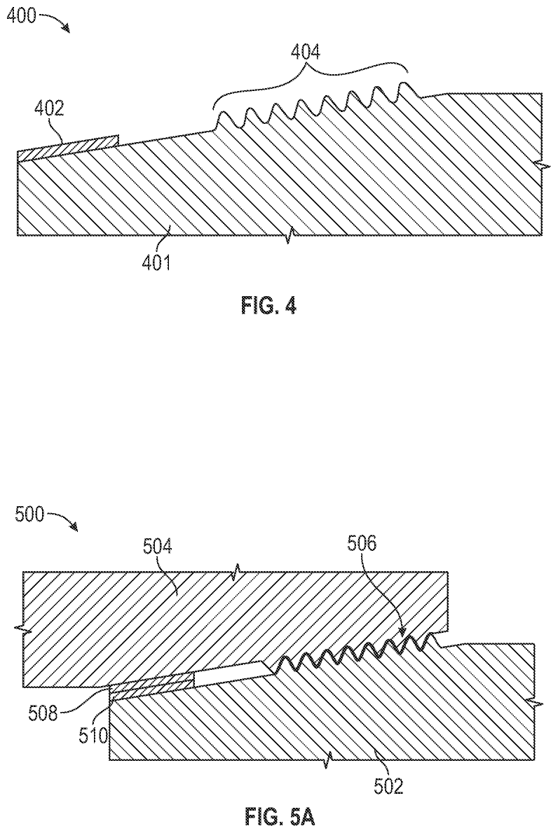

In one or more embodiments, the two RTR pipes are mechanically coupled, such as by threading. After mechanical coupling, the RTR pipe having a tapered, spigot end with a thermoplastic interlayer bonded to an area of the external surface may be aligned with the RTR pipe having a tapered, socket end with a thermoplastic interlayer bonded to an area of the internal surface such that the two thermoplastic interlayers are aligned. FIG. 5A shows a threaded joint 500 of two RTR pipes. As shown in FIG. 5A, an RTR pipe having a spigot end 502 is coupled to an RTR pipe having a socket end 504 via a threaded joint 506. Once the joint is properly threaded, a thermoplastic interlayer of the spigot end 508 is aligned with a thermoplastic interlayer of the socket end 510. A slight gap may exist between the two thermoplastic interlayers. Herein, the area of a mechanically coupled joint that includes two aligned thermoplastic interlayers, such as 508 and 510 in FIG. 5A may be referred to as a “sealing area.”

In one or more embodiments, the thermoplastic interlayers in the sealing area of the jointed RTR pipes are welded together. Any welding process known in the art may be employed to weld the two thermoplastic interlayers together. In particular embodiments, the thermoplastic interlayers are induction welded. Accordingly, in such embodiments, the thermoplastic interlayers include a susceptor. The susceptor may be capable of converting electromagnetic energy into heat. Suitable susceptors include, but are not limited to, carbon black, graphene, graphite, metallic powder, and metallic beads, such as aluminum powder and beads.

Generally, an external heat source may be applied to the mechanical joint in order to weld the thermoplastic interlayers together. In the case of induction welding, externally positioned magnetic coils may be placed near the sealing area of the mechanical joint and may generate electromagnetic energy. As noted above, the electromagnetic energy is converted into heat by the susceptor, thus heating the thermoplastic interlayers. The thermoplastic interlayers may be heated to a temperature required to form a joint between the two interlayers. The resulting joint including a thermoplastic welded seal 520 is shown in FIG. 5B. As shown in FIG. 5B, an RTR pipe having a spigot end 502 is mechanically coupled to an RTR pipe having a socket end 504 via a threaded joint 506 and subsequently exposed to electromagnetic energy generated form externally positioned magnetic coils 512, thus heating and melting the thermoplastic interlayer, to provide a thermoplastic welded seal 514.

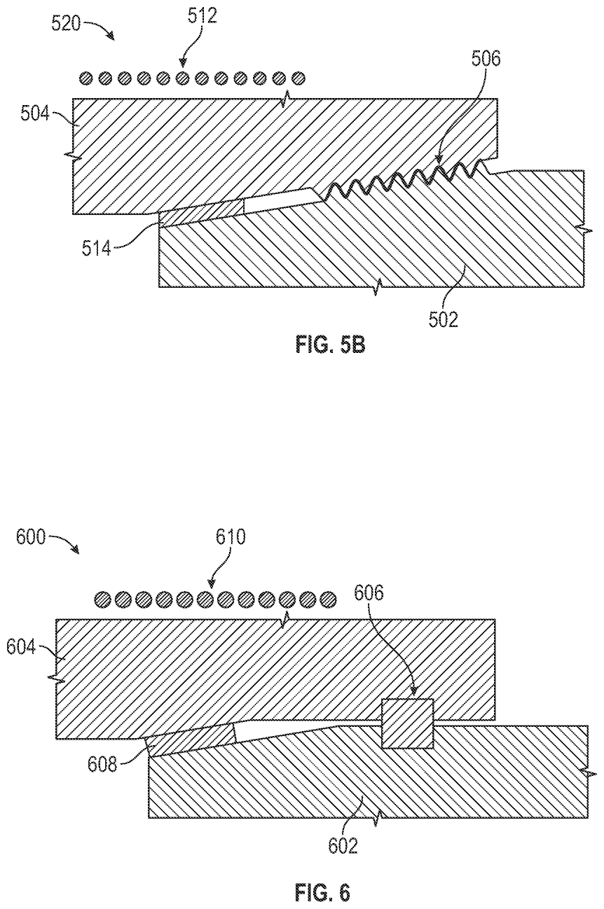

As noted above, the thermoplastic welded seal described herein is designed to be used in combination with conventional mechanical joints. Although FIG. 5B shows a system in accordance with the present disclosure including a thermoplastic welded seal in combination with a threaded joint, such systems may be employed with different mechanical joints as well. For example, a system including a thermoplastic welded seal in combination with a key-lock joint 600 is shown in FIG. 6. In FIG. 6, an RTR pipe having a tapered, spigot end 602 is inserted into an RTR pipe having a tapered, socket end 604 and mechanically coupled by a key-lock joint 606. Magnetic coils 610 are used to heat and melt thermoplastic interlayers, effectively providing a thermoplastic welded seal 608.

Embodiments of the present disclosure may provide at least one of the following advantages. The disclosed systems and methods aim to expand the operating envelop and fluid tightness of RTR pipe joints by providing a reliable sealing system with excellent barrier to the ingress of fluids (liquids and gases) as compared to conventional sealing methods (typically based on elastomer O-rings). Additionally, such systems and methods address lengthy curing times or surface finishing tasks required by the current jointing methods, providing quicker installation. Further, the innovative jointing system alleviates concerns related to corrosion barrier layer being compromised as the groove dimensions for sealing O-rings must accommodate the barrier layer.

The disclosed sealing system can be used as a complementary feature to traditional RTR mechanical joints and can be implemented on both integral and coupled joint technologies. The extent of the resulting seal, which does not depend on a contact pressure to ensure sealing but rather on a permanent bonding, could provide a more reliable option compared to traditional sealing systems (e.g., O-rings), for which the RTR piloting in gaseous application is currently precluded. Furthermore, the method of implementation allows use of a variety of thermoplastic materials, typically with higher mechanical/thermal/barrier properties as compared to elastomeric seals which could offer obvious benefits in terms of reliability and maintenance.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for coupling pipes comprising:
a first pipe having a tapered, spigot end, wherein a portion of an external surface of the tapered, spigot end of the first pipe is bonded to a first thermoplastic material; and
a second pipe having a tapered, socket end adapted to internally receive the tapered, spigot end of the first pipe, wherein a portion of an internal surface of the tapered, socket end of the second pipe is bonded to a second thermoplastic material;
wherein the first pipe and the second pipe are made from a reinforced thermosetting resin (RTR) material,
wherein, when the first pipe is internally received by the second pipe, the portion of the external surface of the tapered, spigot end of the first pipe is positioned to align with the portion of the internal surface of the tapered, socket end of the second pipe, thereby forming a sealing area,
wherein, upon application of a thermal joining process to the first thermoplastic material and the second thermoplastic material, an amount of heat of the thermal joining process is sufficient to melt the first thermoplastic material and the second thermoplastic material such that, when the heat is removed, a hardened thermoplastic material seals the first pipe to the second pipe.

2. The system of claim 1, wherein the first thermoplastic material and the second thermoplastic material each comprise a thermoplastic polymer and a susceptor.

3. The system of claim 2, wherein the thermoplastic polymer is selected from the group consisting of polyolefins, high-density polyethylene (HDPE), polyethylene of raised temperature (PE-RT), PVDF, PTFE, PPS, PEEK, PAEK, polyetherketoneketone (PEKK), polyketone (POK), PEI, and combinations thereof.

4. The system of claim 2, wherein the first thermoplastic material and the second thermoplastic material comprise a same thermoplastic polymer.

5. The system of claim 2, wherein the susceptor is deposited by thermal spraying on a to-be-joined RTR surface.

6. The system of claim 2, wherein the thermoplastic polymer is on top of the susceptor.

7. The system of claim 2, wherein the thermoplastic polymer is deposited by thermal spraying or friction welding.

8. The system of claim 2, wherein the susceptor is on top of the thermoplastic polymer.

9. The system of claim 1, wherein the sealing area is adjacent to a mechanical coupling area of the first pipe and the second pipe.

10. The system of claim 9, wherein the mechanical coupling area comprises a mechanical joint selected from the group consisting of key-lock joints, threaded joints, injected mechanical joints, and combinations thereof.

11. The system of claim 1, wherein the first thermoplastic material and the second thermoplastic material each comprise a thermoplastic matrix and susceptor particles dispersed within the thermoplastic matrix.

12. The system of claim 1, wherein the thermal joining process is an induction welding process.

13. A method of coupling a first pipe having a tapered, spigot end and a second pipe having a tapered, socket end adapted to internally receive the tapered, spigot end of the first pipe, wherein the first pipe and the second pipe are made from a reinforced thermosetting resin (RTR) material and wherein a portion of an external surface of the tapered, spigot end of the first pipe is bonded to a first thermoplastic material and a portion of an internal surface of the tapered, socket end of the second pipe is bonded to a second thermoplastic material, the method comprising:
inserting the first pipe into the second pipe;
coupling the first pipe to the second pipe via a mechanical joint such that the portion of the external surface of the first pipe aligns with the portion of the internal surface of the second pipe to form a sealing area; and
employing a thermal joining process to bond the first thermoplastic material to the second thermoplastic material by heating the first and second thermoplastic materials to melt the first and second thermoplastic materials such that, when the heat is removed, a hardened thermoplastic material seals the first pipe to the second pipe at the sealing area.

14. The method of claim 13, wherein the thermal joining process is an induction welding process.

15. The method of claim 13, wherein the first thermoplastic material and the second thermoplastic material each comprise a thermoplastic polymer and a susceptor.

16. The method of claim 13, wherein the mechanical joint is selected from the group consisting of threaded joints, key-lock joints, and injection mechanical joints.

17. The method of claim 13, wherein the sealing area is adjacent to the mechanical joint.

18. The method of claim 17, wherein the sealing area is located internal to the mechanical joint.
